(19) United States
(12) Patent Application Publication
(10) Pub. No.: US 2016/0067863 A1
(43) Pub. Date: Mar. 10, 2016

(54) WORK STATION WITH REMOVABLE SUB-STATIONS

(71) Applicant: JPL Investments, LLC, Santa Fe, NM (US)

(72) Inventor: Joseph W. Cole, Santa Fe, NM (US)

(21) Appl. No.: 14/941,917

(22) Filed: Nov. 16, 2015

Related U.S. Application Data
(63) Continuation-in-part of application No. 13/759,637, filed on Feb. 5, 2013.
Application No. 13/759,637 is a continuation-in-part of application No. 14/726,122, filed on May 29, 2015.
Application No. 14/726,122 is a continuation of application No. 13/759,590, filed on Feb. 5, 2013, now Pat. No. 9,050,718.
(60) Provisional application No. 62/216,527, filed on Sep. 10, 2015.

(51) Int. Cl. B25H 3/02; B25H 1/12; A47B 87/00; B25H 1/04

(52) U.S. Cl. CPC B25H 3/028; B25H 1/04; B25H 1/12; A47B 87/00

(57) ABSTRACT

A work station has one or more removable sub-stations. Each sub-station comprises a tool box or tool cart, i.e. a structure which defines one or more interior areas for storing tools, parts or other items. The work station defines one or more work surfaces, similar to a work bench, but includes tool storage, similar to a tool box. In addition, the work station is movable and securable. The removability of the sub-stations permits them to be associated with the work station, such as for storage or transport, or be separated therefrom for independent use, such as in a location different than the work station.

### RELATED APPLICATION DATA

This application claims priority to U.S. Provisional Application Ser. No. 62/216,527, filed Sep. 10, 2015, and is a continuation-in-part of U.S. application Ser. No. 13/759,637, filed Feb. 5, 2013, and is a continuation-in-part of U.S. application Ser. No. 14/726,122, filed May 29, 2015, which is a continuation of U.S. application Ser. No. 13/759,590, filed Feb. 5, 2013, now U.S. Pat. No. 9,050,718.

### FIELD OF THE INVENTION

The present invention relates to work benches and tool boxes at which tools and work pieces are used and stored.

### BACKGROUND OF THE INVENTION

Tool boxes and work benches have changed little over the years. Tools are commonly stored in tool boxes. Such tool boxes may be relatively small so that they can be carried from one location to another, or may be relatively large and then supported by wheels so as to be rollable from one location to another.

While tools are stored in tool boxes, they are commonly used at work benches. Work benches generally comprise stationary platforms which define a raised work surface.

Existing tool boxes and work benches have a number of drawbacks. First, the tools are generally stored in the tool boxes, while they are used at a work bench. The different locations for tool storage and use means that person must move tools from one location to another. Also, the stationary nature of work benches prevents a user from having a convenient work surface if a project needs to be completed far from the work bench. Lastly, security problems often arise when storing tools, such as in public settings.

The present invention is directed at overcoming these and other shortcomings of the prior art.

### SUMMARY OF THE INVENTION

One aspect of the invention is a work station having one or more removable sub-stations. Each sub-station comprises a tool box or tool cart, i.e. a structure which defines one or more interior areas for storing tools, parts or other items. The work station defines one or more work surfaces, similar to a work bench, but includes tool storage, similar to a tool box. In addition, the work station is movable and securable. The removability of the sub-stations permits them to be associated with the work station, such as for storage or transport, or be separated therefrom for independent use, such as in a location different than the work station.

Further objects, features, and advantages of the present invention over the prior art will become apparent from the detailed description of the drawings which follows, when considered with the attached figures.

### DESCRIPTION OF THE DRAWINGS

FIG. 1 illustrates a work station in accordance with one embodiment of the invention;

FIG. 2 illustrates the work station of FIG. 1 with a sub-station being removed therefrom;

FIG. 3A illustrates the work station of FIG. 2 with the sub-station completely removed;

FIG. 3B illustrates the work station of FIG. 3A with a different sub-station being associated therewith;

FIG. 4 illustrates a back of the work station of FIG. 1;

FIG. 5 illustrates an embodiment of a work station in accordance with the invention showing doors being closed;

FIG. 6 illustrates a door track configuration of the invention;

FIG. 7 illustrates a tool mounting configuration for a work surface of the invention; and

FIG. 8 illustrates a door securing configuration of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a work station having one or more removable sub-stations. In one embodiment, each sub-station comprises a tool box or tool cart, i.e. a structure which defines one or more interior areas for storing tools, parts or other items. Preferably, the work station defines one or more work surfaces, similar to a work bench, but includes tool storage, similar to a tool box. In addition, the work station is preferably movable and securable. The removability of the sub-stations permits them to be associated with the work station, such as for storage or transport, or be separated therefrom for independent use, such as in a location different than the work station.

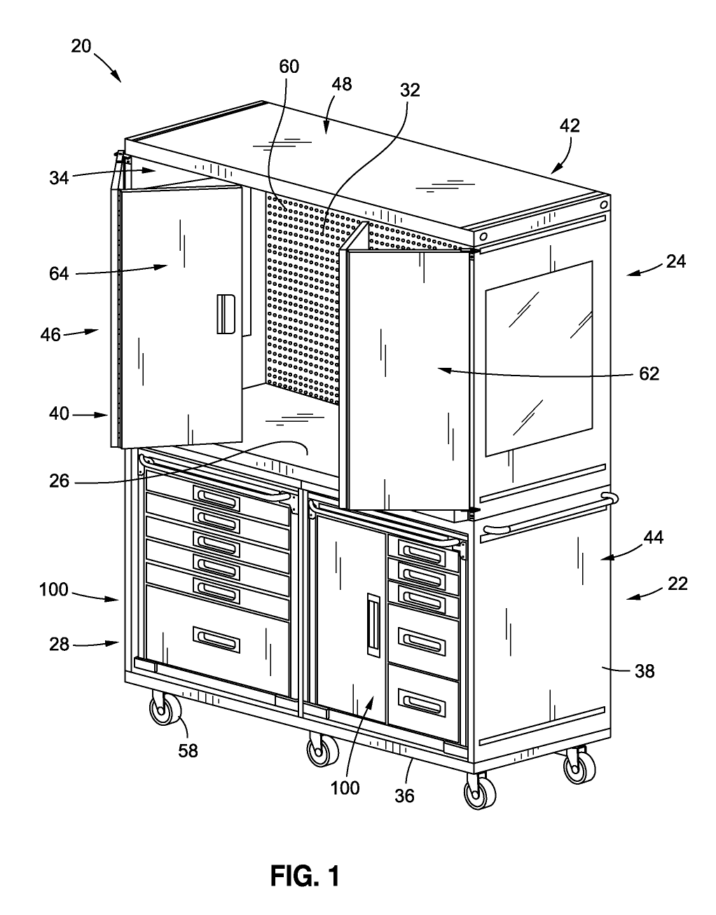

One embodiment of the invention will be described with reference to FIG. 1. As illustrated, the work station 20 has a lower, base portion 22 and an upper, work bench portion 24.

The base portion 22 preferably defines one or more interior storage areas 28 and includes a work surface 26. The work bench portion 24 preferably defines a work back 32 and, in cooperation with the work surface 26, an interior area 34.

In one embodiment, the base portion 22 comprises a base or platform 36. The platform 36 may comprise, for example, a generally planar rigid support. The base portion 22 also preferably comprises a housing 38. Preferably, the one or more interior storage areas 28 are defined at least in part by the housing 38.

In one configuration, the housing 38 may comprise a frame. The frame might comprise, for example, a super-structure or set of supports to which other elements are mounted. In other configurations, panels or the like may be connected to one another (such as directly or via one or more connectors) to define the housing 38.

In one embodiment, the work station 20 generally has a front 40, an opposing back 42, a first side 44, an opposing second side 46, a top 48 and a bottom. In one embodiment, the bottom may be defined by the platform 36. In other embodiments, the bottom may comprise one or more elements which are separate from the platform 36. In the configuration which is illustrated in FIG. 1, the housing 38 is generally rectangular in shape and may be about 50-56 inches, and most preferably about 53 inches wide (from side to side), about 18-24 inches, and most preferably about 20 inches deep (from front to back), and 36-46, and most preferably about 42 inches tall (from top to bottom). Of course, the housing 38 might be square or have other shapes. As illustrated, the platform 36 may have slightly larger dimensions in one or more directions, such as for the mounting of other components.

As indicated, the housing 38 preferably defines one or more interior areas. In one embodiment, at least a portion of the interior area is generally enclosed or enclosable. For example, as illustrated, the first and second sides 44,46 may be enclosed, such as by panels (in other embodiments, the sides may be selectively opened and closed, such as with movable panels, doors or the like). Likewise, the back 42 may be closed by one or more panels or doors. As described below, in one embodiment the interior storage space 28 of the base portion 22 may be accessed from the front 40. Thus, the front 40 of the work station 20 may be open in that location or one or more portions of the front of the work station 20 may also be selected opened and closed, such as with doors or the like.

While the base portion 22 of the work station 20 is preferably generally enclosed, it is possible for the base portion 22 to be generally open. For example, struts or supports might extend upwardly from the four corners of the platform 36 to the work surface 26, thus supporting the work surface 26 above the platform 26. However, the space between the struts or posts might be open, thus providing access to the interior storage area 28 from the front, sides and/or back.

In a preferred embodiment, the work surface 26 is located between the top and bottom of the work station 20, such as generally midway therebetween or at a convenient work height, such as between 36 and 42 inches (from the ground). In this configuration, the interior area 34 comprises a generally open work area located between the work surface 26 and the top 48 of the work station 20. In another embodiment, it is possible for the work surface 26 to comprise or define the top of the work station 20 (e.g. the work station 20 does not include a work bench portion 24 above the work surface or top of the base portion 22).

In one embodiment, the work surface 26 has a top which is generally planar and solid. The work surface 26 might be defined, for example, by a sheet of wood. However, the work surface 26 could be plastic, metal or the like. In one embodiment, the work surface 26 has two opposing sides with different configurations. The user may orient either side of the work surface 26 upwardly to comprise the top, such as by detaching the work surface 26 from the work station 20, flipping it over and reconnecting or attaching it. As detailed below, the work surface 26 might include various tool mounting elements or locations, tracks, slots or the like. The configuration of those tool mounts, for example, might vary on each side of the work surface 26. As one example, a first set of tool mounts for vises might be provided on a first side of the work surface 26, while a second set of tool mounts for a jig, router or the like might be provided on the second side of the work surface 26. In this manner, the work surface 26 may have sides which have different configurations for different uses. In one embodiment, opposing sides of the work surface 26 might comprise different materials, such as metal on one side and wood on the other.

In the preferred configuration where the work station 20 is mobile, the base portion 22 is rollably supported. For example, the platform 36 may be rollably supported by a plurality of casters or wheels 58. Of course, the work station 20 might be movably supported by roller-balls, tracks or other elements.

In one embodiment, the platform 36 is supported by six wheels 58. Three wheels 58 are preferably spaced along the width of the platform 36 at its front (as illustrated in FIG. 1) and three wheels are preferably spaced along the width of the platform 36 at its rear (not shown). In such a configuration, two wheels 58 may be located at each side or end of the platform 36 and another pair of wheels 58 may be located near the middle of the platform 36. In such a configuration, the size and/or placement of the wheels 58 may enable the platform 36 to be tipped or tilted from end to end. For example, a set of wheels 58 at one side/end may be smaller or set higher than the others, permitting the work station 20 to be tipped in that direction (thus raising the wheels at the opposite end of the platform 36 upwardly, such as to aid a user in passing the work station 20 over a cord, door sill or other obstacle).

In another embodiment, the work station 20 might be supported on legs or struts, such as to impede movement of the work station 20 and/or make the work station 20 more stable during use. In one embodiment, the wheels 58 might be mounted on posts which slide into corresponding passages in the bottom of the work station 20. A user might pull the wheels out and replace them with legs or struts which have similar posts for engaging the same passages. In an embodiment where the wheels 58 are of different sizes, as detailed above, a user might tilt the work station 20 to aid in replacing the wheels with the legs or struts.

As indicated, the work station 20 preferably includes a work bench portion 24. In one embodiment, the work bench portion 24 is connected to the base portion 22. The work bench portion 24 preferably includes a work back 32. In one embodiment, the work bench portion 24 has generally opposing first and second sides and a generally opposing front and back, in similar fashion to the base portion 22. In one embodiment the work back 32 is located at the back of the work bench portion 24. The work back 32 may, for example, be connected to and extend between the two sides 44,46.

In a preferred embodiment, the work back 32 comprises one or more generally planar panels. Preferably, the panels are configured to support one or more tools, work pieces or other elements. As one example, the work back 32 may comprise one or more peg boards. These boards are generally planar and define a plurality of apertures 60 there through. The apertures 60 are configured to accept tool mounts, such as pins, hangers or the like.

The work back 32 may be constructed from various materials, including wood. In a preferred embodiment, the work back 32 is generally opaque. However, in other embodiments, the work back 36 might be generally transparent, thus permitting light from behind the work station 20 to illuminate the interior 34 and permitting a user to see through the work back 32 to the area behind the work station 20.

The sides 44,46 of the work station 20 at the work back 32 may be defined at least partially by side panels. Those side panels may have various configurations. Again, the side panels may be opaque or transparent. The side panels might comprise or include, for example, peg boards or other elements which are preferably designed to store, support and/or mount one or more tools, work pieces or the like.

Likewise, in a preferred embodiment, the top 48 of the work bench portion 24 is preferably closed.

The work station 20 may have a variety of other features or elements. For example, one or more work lights might be mounted to the work station 20. The work station 20 might include one or more power strips (such as defining power plugs or the like).

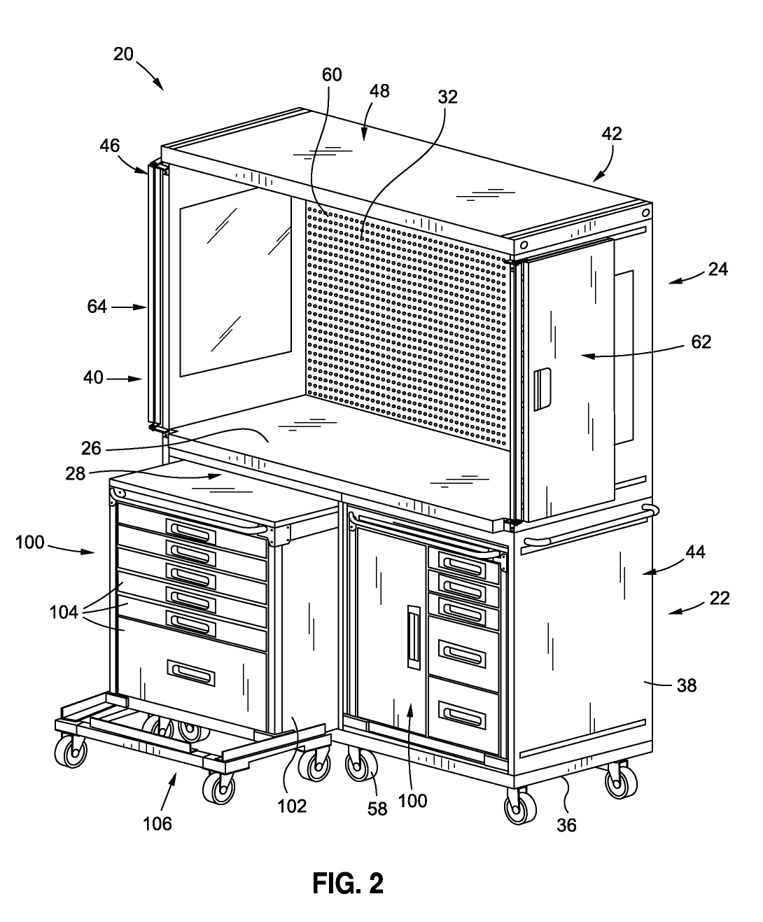

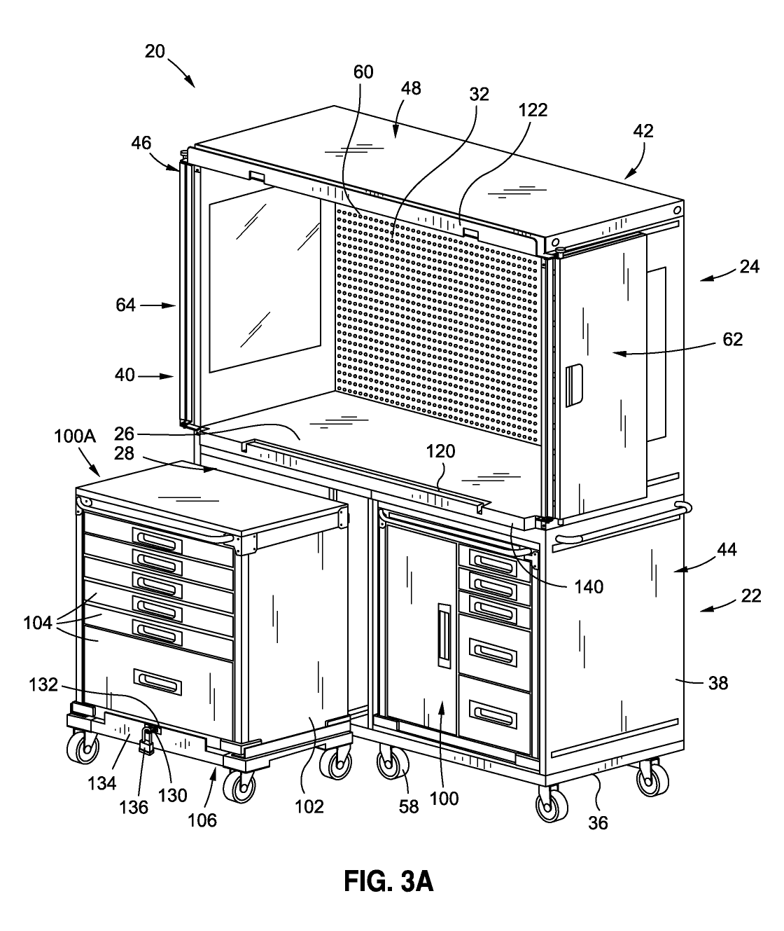

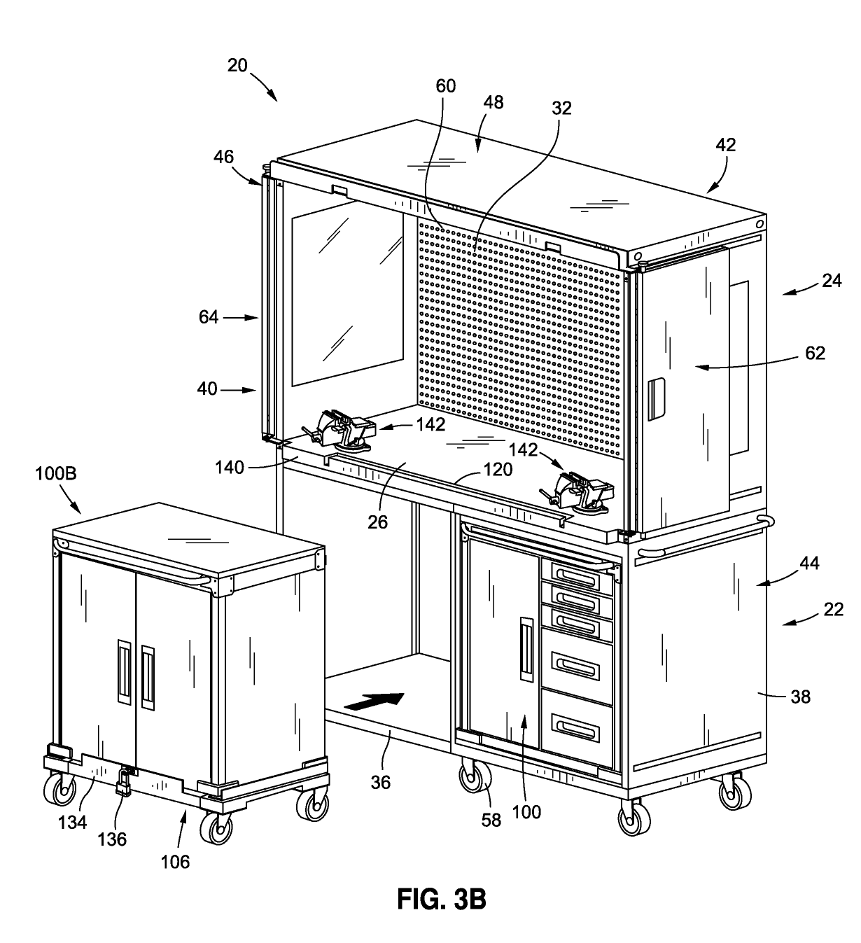

In one embodiment, access to the interior area 34 above the work surface 26 is provided at the front 40 of the work station 20. As illustrated in FIG. 1, one or more doors or panels may be provided for selectively closing all or a portion of the front of the work station 20. In one embodiment, doors or panels may be provided for selectively closing the front of the work bench portion 24. In the embodiment illustrated, first and second front doors 62,64 may be configured to selectively close the front of the work bench portion 24. In one embodiment, a first door 62 may be hingedly or rotatably mounted at the first side 44 of the work bench portion 24, and a second door 64 is similarly mounted at the second side 46 of the work bench portion 24. As indicated in FIG. 1, the doors 62,64 might be bi-fold type doors which each comprise two panels which are hingedly connected. The first and second doors 62,64 may be configured to rotate between a first, closed position (the doors 62,64 are shown partially closed in FIG. 1) and a second, open position (as shown in FIGS. 2 and 3). When in their closed position, the doors 62,64 may be lockable, such as to prevent access to the interior 34. For example, one or more locking members or elements might be used to connect the doors 62,64 to one another (such as via mounts and a padlock, rotating key lock, etc.) and/or such locking member or elements might be used to lock the doors 62,64.

In one embodiment, the doors 62,64 are configured to be moved from a closed position to an open position in which they are located adjacent to the exterior of the sides 44,46 of the work station 20, such as oriented generally parallel thereto. A mounting configuration for a first door 62 is illustrated in FIG. 8, it being understood that the mounting of the other door 64 may be the same. As illustrated in FIG. 8, the door 62 may be hingedly or rotatably mounted to one or more mounts 110 which extend laterally outwardly of the side 44 of the work station 20 (as illustrated, mounts may be provided relative to the top and bottom of the door; the mounts preferably extend outwardly by a distance approximately equal to or greater than the thickness of the door). The door 62 may be mounted by pins or the like to those mounts 110. As illustrated in FIG. 8, this mounting permits the door 62 to be rotated flat against the side 44 of the work station 20.

In the case where the doors 62,64 are bi-fold doors, the doors may comprise a plurality of panels, such as panel P1 and P2 illustrated in FIG. 8. In this configuration, a first side of the first panel P1 is hingedly or rotatably mounted to the mounts 110 and a second side of the first panel P1 is hingedly or rotatably mounted to the second panel P2. This allows the first panel P1 to be folded or rotated against the side 44 of the work station 20 and allows the second panel P2 to be folded or rotated against the first panel P1 in accordion-like fashion.

In one embodiment, means may be provided for securing the doors 62,64 in an open position. Such means may comprise various types of fasteners, connectors or the like. For example, in one embodiment where the doors are metal, one or more magnets may be used to secure the first panel P1 to the side 44 of the work station 20 and/or to secure the second panel P2 to the first panel P1. In another embodiment, clip-type fasteners 112 or other fasteners may be utilized.

As indicated, the doors 62,64 may also be moved to a closed position. In one embodiment, positioning and securing of the doors in the closed position may be facilitated by one or more mounting configurations. As illustrated in FIG. 8, in one embodiment the door 62 may include a first upper pin, roller or similar mount 114 and a second lower pin, roller or similar mount 116. These mounts 114,116 may be located at the end of the door 62 generally opposite its mounting to the work station 20.

The second or lower mount 116 is preferably configured to engage a slot 120 in the work station 20, and most preferably the work surface 26. As illustrated in FIGS. 3A and 3B, the slot 120 may have one or more access portions which extend inwardly from a front edge of the work surface 26 and a second portion which extends generally parallel to that edge. In another embodiment, two slots might be provided, one for each door.

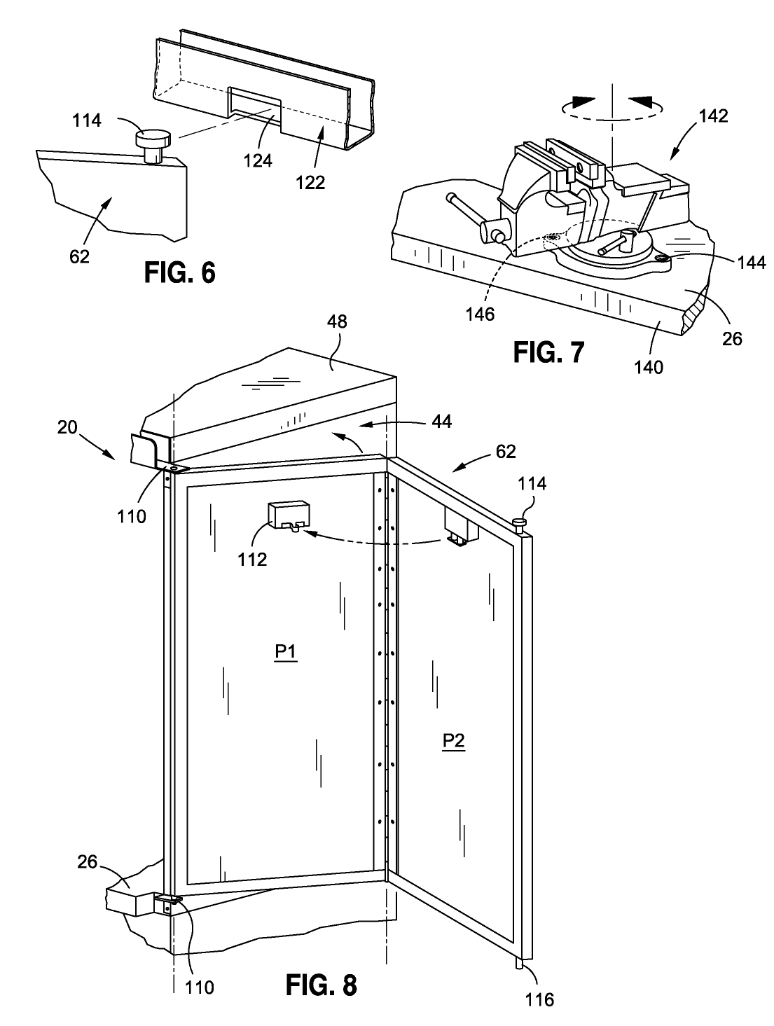

Likewise, the first or upper mount 114 is preferably configured to engage a track 122, such as illustrated in FIGS. 3A and 6. The track 122 may be located near the top of the work station 20. The track 122 preferably defines a generally enclosed slot or the like which allows the upper mount 114 to move linearly along the track, but not out of the track, except at one or more openings 124. In another embodiment, the upper mount 114 is biased upwardly, such as by using a coil spring to bias a pin of the mount (which may support a wheel or roller). The user may press the upper mount 114 downwardly to allow it to be aligned with the track and may then release the upper mount 114, allowing it to bias upwardly into engagement with the track (retaining it in place, and in one embodiment the top of the track may be closed to prevent a user from releasing the door when it is closed and locked by pressing down on the upper mount 114). Again, in another embodiment, two separate tracks might be provided, one for each door.

So configured, a user may rotate the door 62,64 towards the front of the work station 20. The user aligns the top mount 112 with the track opening 124 and aligns the bottom mount 114 with the access portion of the slot 120 (preferably, the location of the first portion of the slot 120 and the track opening 124 are selected so that the upper and lower mounts 112,114 align therewith at the same time). Once the top and bottom mounts 112,114 are in the respective track opening and slot, the user presses the door inwardly. The user then slides the door laterally, as guided by the track 122 and slot 120, until the door is closed.

As indicated, one or both doors 62,64 may include a lock which prevents the door 62,64 from being opened. In one embodiment, the lock might simply comprise a latch-type lock which connects the two doors 62,64, preventing them from being moved laterally back along the track/slot to the open position. In this manner, the interior area 34 may be utilized as a secure storage area, such as for securing tools, work pieces, parts and the like, when work station 20 is unattended, being transported or the like.

In one embodiment, one or more sub-stations 100 are removably located in the work station 20 and, most preferably, within the interior storage space or area 28 of the base portion 22. FIG. 1 illustrates an embodiment where two sub-stations 100 are located in the work station 100.

Referring to FIG. 3A, each sub-station 100 may comprise a tool box, tool cart or similar structure which is designed to house/store tools, parts or other items. Preferably, each sub-station 100 comprises a structure which may stand alone, e.g. can be removed from the work station 100 and still store tools, parts or other items. Each sub-station 100 thus preferably comprises a generally enclosed structure which defines or more interior areas in which tools, parts or other items may be stored.

For example, each sub-station 100 may comprise a housing 102 which generally defines an interior space. One or more storage elements 104 may be located in the interior space. Those storage elements 104 might comprise, for example, one or more drawers, shelves, trays, bins, totes, or the like. Preferably, the storage elements 104 are movable from a first position in which they are located generally within the housing 102 (such as where a front of the storage element 104 then forms a portion of the front of the sub-station 100 or is positioned behind a door thereof) and a second position in which they are extended outwardly of the housing 102 (such as by extending outwardly of a front of the housing 102). In this regard, the storage elements 104 may be movably mounted to the housing 102, such as by slides, rollers or other mechanisms which permit the storage element 104 to be moved between its first/retracted and second/extended/removed positions (of course, each storage element 104 might be moved to one or more intermediate positions, such as a partially open position).

The sub-station 100 may have various other features. In one embodiment, a top of the sub-station 100 is generally planar, such as to be used as a work surface (the work surface might include pre-configured or located mounts, apertures, brackets or the like, such as for mounting tools or workpieces thereto). The sub-station 100 might include one or more handles to aid in moving the sub-station 100. The one or more storage areas might be lockable. The sub-station 100 might include one or more doors for selectively closing the interior space, including the storage elements therein

Each sub-station 100 is configured to be supported by the work station 20, so as to be moved with the work station 20. In a preferred configuration, each sub-station 100 is configured to fit substantially within the interior space 38 of the base portion 22. Therefore, the dimensions, such as the depth, height and width, of the sub-stations 100 may be selected based upon the dimensions of the interior area 28. In one preferred embodiment, the sub-stations 100 are sized to permit two sub-stations to fit side by side in the work station. However, they might be of other sizes (such as where only a single sub-station might fit into the work station 20 or more than two might fit, such as three or four or more; further the sub-stations might be positioned side by side in the work station or might be stacked).

In one embodiment, each sub-station 100 may be configured to sit or rest upon the platform 36 of the work station 20. In another embodiment, each sub-station 100 might be configured “dock” with the work station 20. For example, in one embodiment the platform 36 might define one or more openings. Each sub-station 100 might be supported by wheels and be configured to roll into one of the openings defined by the platform 36. Each sub-station 100 might lock or connect to the work station 20 to secure it in position. In this configuration, each sub-station 100 may be supported by its own wheels, but be connectable to the work station 20 to form a part of the work station and move with the work station, but be detachable from the work station 20.

In another embodiment, each sub-station 100 might be removed from the work station 20 and supported by another support, such as a dolly 106, such as illustrated in FIG. 2. The dolly 106 might comprise a wheeled support which is approximately the same height as the platform 36, thus permitting a user to slide the sub-station 100 onto it, as illustrated in FIGS. 2 and 3A

In order to aid the user in moving the sub-station 100 to its removed position, the sub-station 100 might rest on rollers, slides or other elements, such as positioned between the sub-station 100 and the platform 36.

As illustrated in FIGS. 3A and 3B, the configuration of the work station 20 allows one sub-station to be removed from the work station 20 and then be re-associated with the work station 20, but also allows one sub-station to be removed from the work station 20 and be replaced by a different work station. For example, FIGS. 3A and 3B illustrates a configuration where one sub-station 100A is removed from the work station 20 and a different sub-station 100B is associated with the work station 20.

In one embodiment, a sub-station 100 may be secured to its corresponding dolly 106 and/or to the work station 20. For example, as illustrated in FIG. 3A, the sub-station 100A may include a connector 130, such as a “U” shaped loop, which extends outwardly from a front thereof. This connector 130 may be configured to pass through a slot 132 in a flange 134 which extends upwardly at the front of the dolly 160. This permits a user to connect a lock 136 through the connector 130, locking the sub-station 100A to the dolly 160.

Of course a variety of other locking configurations may be utilized. For example, a first member, such as controlled by a lock and key, might be associated with the dolly 106 and be movable into and out of engagement with the sub-station 100A, or vice versa.

Similarly, a sub-station 100 might be locked or secured to the work station 20. For example, when the sub-station 100 includes a connector 130, the work station 20 might include a similar aligned connector, such as associated with the platform 36, thus permitting the user to connect a lock through those connectors (which lock might be the same lock as is used to secure the sub-station to the dolly 106 when the sub-station 100 is disconnected from the work station 20).

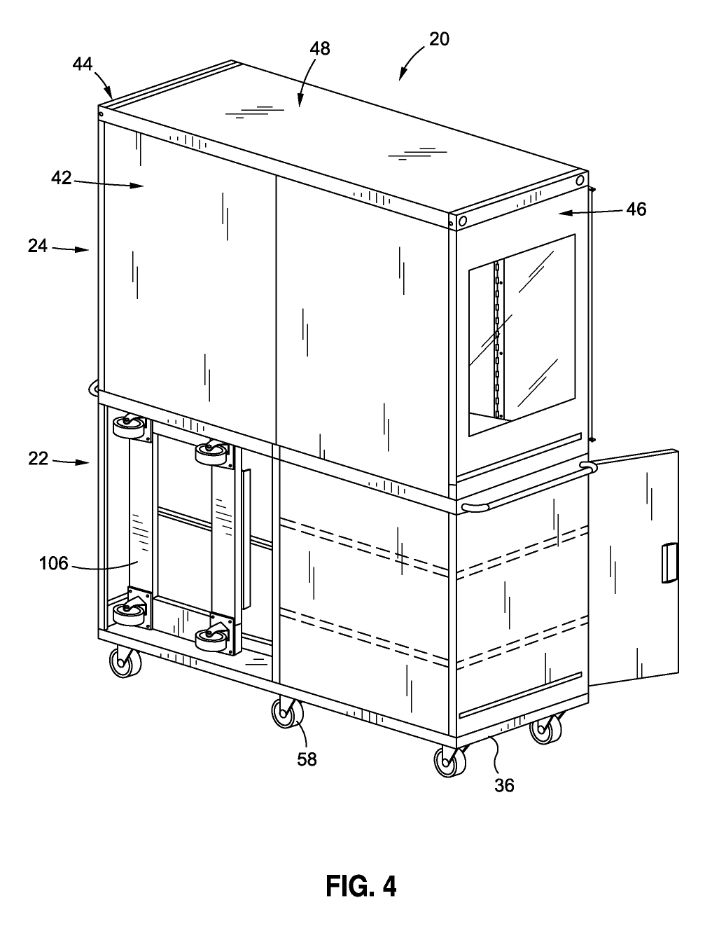

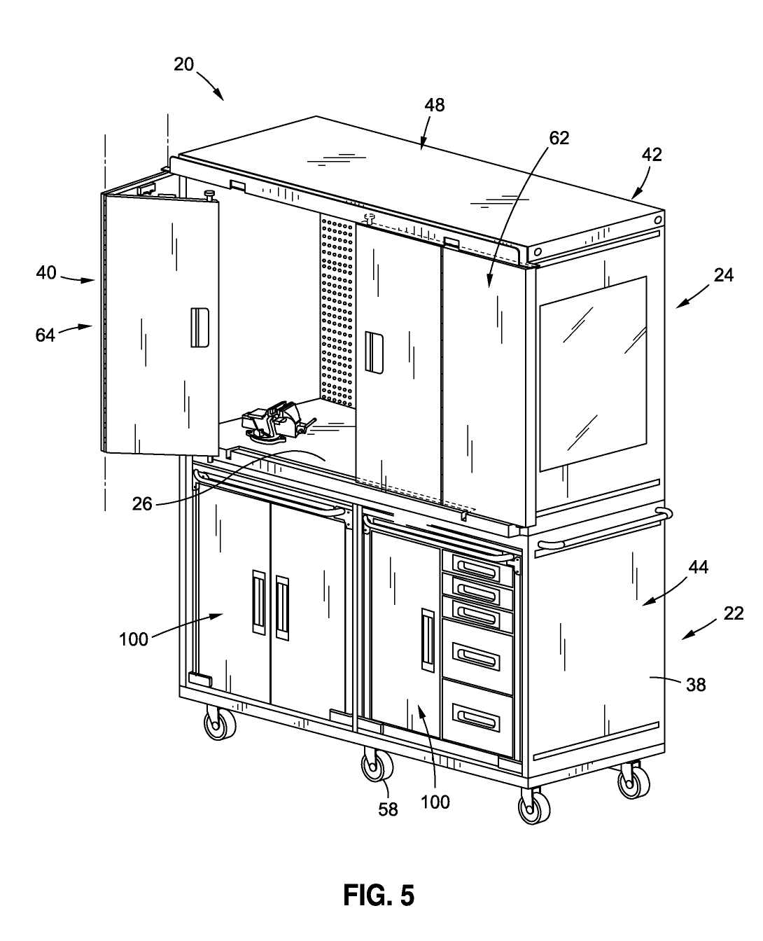

The interior area 28 of the base portion 22 might be accessible from the rear of the work station 20. For example, one or more rear doors or other panels may provide access to the interior 28 at the back 42 of the work station 20, such as illustrated in FIG. 4. In embodiment, one or more dollies 102 might be stored therein, such as between the one or more sub-stations 100 and the back of the work station 20.

In one embodiment, the work station 20 may include one or more doors or other elements which may be moved from an open or retracted position which permits access to the front of the interior area 28, and thus the sub-stations 100, and a closed position which generally encloses the front of the interior area 28, and thus prevents access to the sub-stations 100. In this manner, the sub-stations 100 may be enclosed, such as to secure them within the work station 20 and prevent access thereto (including to the tools therein). For example, one or more locks might be used to lock the one or more doors or panels in a closed position.

Additional aspects of the invention will now be described.

In one embodiment, a unique tool mount configuration is provided, which tool mount configuration has particular applicability to the work station 20. As illustrated in FIGS. 3A and 3B, in one embodiment, a front edge 140 of the work surface 26 extends outwardly of the front of the work station 20. Preferably, the front edge 140 of the work surface 26 extend outwardly or forwardly beyond at least the portion of the sides 44,46 of the work station 20 above the work surface 26.

As illustrated in FIG. 7, one or more tools, such as vises 142, are mounted or mountable to the work surface 26 in more than one location. Preferably, the tools are mounted so that they can be moved from a first retracted position to a first extended position. In the retracted position, the tool is mounted so that it is positioned inside of the interior area 34, thus permitting the doors 62,64 to be closed (with the tool located inside of the work station 20). In the extended position, the tool is mounted so that at least a part of the tool is extends past the front of the work station 20, such as beyond the sides 44,46.

For example, as illustrated in FIG. 7, a vise 142 is mounted to the work surface 26 via a first mount 144 and a second mount 146. In one embodiment, the first mount 144 comprises a pin or other fastener which connects the vise 142 to the work surface 26 but permits pivoting of the vise 142. The second mount 146 is adjustable, e.g. allows the vise 142 to be secured in either its retracted or extended position. For example, the second mount 146 might comprise one or more fasteners which may engage a front or a back aperture in the work surface 26.

As one example, the first mount 144 might comprise a bolt which passes through a flange of the vise 142 into a threaded aperture in the work surface 26. The second mount 146 might also comprise a bolt which passes through flange of the vise 142 into engagement with either a forward threaded aperture in the work surface 26 or a rear threaded aperture. In order to engage the rear threaded aperture, the vise 142 is preferably pivoted to its retracted position. In its extended position, the vise 142 is preferably rotated so that the bolt will pass through the flange into the forward aperture.

Of course, other types of mounting may be utilized which permits the tool to be moved between retracted and extended positions, such as tracks or the like. Preferably, in the forward or extended position, the tool is preferably positioned so that it is usable forwardly of the work station 20. For example, in the case of a vise 142, the vise is preferably positioned so that it can hold workpieces in front of the work station 20. As one example, the vise(s) 142 might be used to hold a pipe which is longer than the work station 20 is wide by supporting the pipe in front of the work station (including the sides 44,46 thereof).

As illustrated in FIG. 3B, multiple tools or tool holders might be mounted to the work surface 26, such as at opposing sides thereof.

One embodiment of the invention is a movable work station. The work station preferably includes or defines at least one work surface. Most preferably, the work station defines one or more storage areas in the form of one or more sub-stations. The one or more sub-stations are preferably removable from the work station. In such a configuration, the sub-station(s) may be associated with the work station and be used therewith, or be separated from the work station to be used separately.

As one example, a user may store tools, parts or other items in the one or more sub-stations. When the sub-stations are associated with the work station, such as in a configuration illustrated in FIG. 1, the tools, parts or other items are convenient to the work station, such as for use at the work surface. Further, the sub-stations are conveniently stored within the work station and can be moved with the work station. For example, a user might wish to work in their garage and thus locate the work station in their garage. If the user wished to work on their driveway, such as adjacent to a car, the user could roll the work station to the driveway. When the user does this, the sub-stations, including the tools, parts and other items stored therein, are conveniently moved with the work station.

On the other hand, a user might wish to have access to some tools, parts or other items separately from the work station. In such a configuration, the user may remove a sub-station (or more than one, if the work station includes more than one sub-station). In a preferred embodiment, the user may separate the sub-station and then move it, such as by rolling, to a location which is different than the location of the work station. For example, a user might take a work station to a job site in a van or truck. The user might separate one of the sub-stations from the work station and roll the sub-station into a building or the like.

In accordance with the invention, the work station has the features of a work bench and one or more tool boxes, but integrates them in a way that overcomes problems with existing work benches and tool boxes.

In one embodiment, a sub-station 100 may be configured as a self-contained unit, such as for a specific application or purpose. For example, a sub-station 100 might be configured to hold certain tools, work pieces or the like, such as for a particular application or job. As one example, relative to a particular aircraft repair application, a sub-station 100 might be equipped with a certain configuration of tools and parts. The sub-station 100 may have drawers or other storage areas which are specifically designed to hold the tools or parts. For example, the drawers might include tool holders, such as foam holders having tool or parts cut-outs formed in them for specific tools and/or parts, may have templates or the like for defining designated locations for particular tools and/or parts. In this manner, a visual determination may be made as to whether the sub-station 100 contains all of the required tools and/or parts (such as after use of the sub-station, such as to verify that no tools were left in the aircraft).

One aspect of the invention comprises a secure work station and methods, devices and systems for securing a work station and/or sub-stations. In one embodiment, one or more means are provided for detecting or determining when the work station 20 or a sub-station 100 has been accessed and/or for determining if there has been an alteration or modification to or tampering with the work station 20 or a sub-station 100.

In one embodiment, the sub-station 100 and/or work station 36 might include one or more scales or other mass measuring devices. For example, a scale might be associated with the work station 20, such as in or at the platform 36 at the location of each sub-station 100. In another embodiment, a scale(s) may be associated with the sub-station 100, such as at a bottom thereof. The scale(s) may provide an output of the mass of a sub-station 100, such as when the sub-station is located in the work station 20. In one embodiment, the scale(s) may include one or more displays for displaying an output of a measured mass. In other embodiments, the scale(s) might include a wired or wireless transmitter or transceiver for transmitting the measured mass information to a remote device such as a laptop, PDA, phone, tablet, reporting system or the like. In another embodiment, one or more mass or weight measuring devices might similarly be associated with the work station 20 to measure the mass thereof. For example, mass measuring devices might be associated with the wheels 58 (such as the mounting posts thereof), where the output of the multiple devices may be used to determine the weight of the work station 20.

In one embodiment, a user may utilize the output of the scale(s) or other mass measuring device(s) to determine the weight/mass of the work station 20 and/or a sub-station 100. Changes in mass may be used to identify changes in the condition of the work station 20 and/or sub-station 100. For example, if the mass of a sub-station 100 changes between the time it is removed from the work station 20 and when it is returned to the work station 20, the change in mass may be used to identify that the all of the designated tools and/or parts have not been returned to the sub-station 100.

In one embodiment, user-access controls may be provided to the sub-stations. For example, one or more locks might be used to lock the sub-stations 100 to or inside the work station 20. The locks might include, for example, a user lock ID and means for tracking use of the lock, whereby information such as the identity of the user, time of access and/or other information might be gathered and track. For example, such a lock might store information which indicates that User 1 unlocked and removed a sub-station from the work station at 1 pm on Monday and returned it at 3 pm that same day, and that User 2 unlocked and removed the same sub-station at 4 pm that same day (for example, User 1 and 2 might have different unlocking codes or might be required to enter a user ID or PIN code when unlocking the lock).

A similar locking mechanism might be used on a sub-station 100 to control access to the interior of the sub-station and to track access thereto. A similar locking mechanism (such as associated with doors of the work station 20) might be used on the work station 20 to control access to the interior thereof.

As indicated, the locks, mass measuring devices and the like may provide outputs to one or more other devices, such as user identification and also reporting capability. The detected, recorded and/or transmitted information might be time stamped and/or provide other secondary information. Such reporting may be by a wireless communication link to a mobile device, computer or the like, and/or via a display or other device. In this manner, the weight of the work station 20 and/or individual sub-stations 100 may be detected or determined (and variations in weight, such as due to a tool or part not being returned) and/or access to the work station 20 and/or individual sub-stations 100 may be detected or determined, thus providing a high level of access control and monitoring. For example, a first user (such as identified by a first user access code which is input by the first use into a lock which secures the sub-station 100 to the work station 20) might access a sub-station 100 and return it will all components (as detected by no change in weight between when the sub-station 100 is removed and when it is replaced). A second user might later access a sub-station 100 and fail to return a particular tool. By examining the reported weight of the sub-station 100 as tied to each identified user, an owner of the work station 20 can determine that the second user was the user who accessed the sub-station 100 and did not return it with all required components.

The locks, mass measuring devices or the like may also provide security alerts. For example, when a sub-station 100 is removed the measured mass at the work station 20 will change. This may be reported to a third party device or system, such as in the form of an alert of a change to the work station 20.

It will be appreciated that the principles of the invention may be applied to other work stations than as specifically described and illustrated herein. For example, a work station might simply comprise a base portion having a top work surface (e.g. not include a top portion including a work back, etc.). Alternatively, the work station could have other features or configurations and still include one or more removable sub-stations.

It will be appreciated that the work station and associated one or more sub-stations could have various shapes and sizes. For example, a smaller work station might have a single removable sub-station, while a longer or larger work station might have 2, 3 or even more removable sub-stations. In this regard, the work station of the invention may have other features or configurations, such as having a movable top portion or other features as disclosed in parent U.S. application Ser. No. 13/759,950, filed Feb. 5, 2013, the disclosure of which is incorporated by reference herein in its entirety, or having adjustable shelves, slidable totes or drawers or other features as disclosed in parent U.S. application Ser. No. 13/759,637, filed Feb. 5, 2013, the disclosure of which is incorporated by reference herein in its entirety.

In one embodiment, the work station 20 may be modular. For example, the work station 20 might be configured as a base module which includes the base portion 22. A user might select or purchase from a variety of different sub-station 100 configurations for association with the base portion 22. The user might also select or purchase different work surfaces 26. A user might also separately obtain the work bench portion 24 for association with the base portion 24, and/or separately obtain the doors 62,64 for the work bench portion 24, doors for the base portion 22, etc. In this regard, various connections or connectors may be integrated into the portions of the work station 20, such as to facilitate connection of the work bench portion 24 to the base portion 22.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A modular, securable tool work station comprising:
a frame, said frame defining a front, an opposing rear, a first side, an opposing second side, a bottom and a top of said work station, a sub-station storage area above said bottom and accessible from at least said front of said work station, said frame being rollably supported;
a workbench, said workbench positioned above said sub-station area;
a workback extending upwardly from said workbench at said rear of said work station whereby a work area is accessible from said front of said work station between said sides and in front of said workback;
at least one door for selectively closing said front of said work station at said work area; and
at least one sub-station which may be located in said sub-station area or removed therefrom, said at least one sub-station comprising a frame defining at least one storage area therein, whereby sub-stations having different configurations may be selectively associated with said work station or be removed therefrom.

2. The work station in accordance with claim 1, wherein said sub-station comprises a generally closed housing having first and second sides, a front, a rear, a top and a bottom, said top defining a work surface and further comprising one or more storage elements, said storage elements movable between a first retracted position inside said storage area and a second extended position in which at least a portion of said storage element extends outwardly of said front of said sub-station.

3. The work station in accordance with claim 1 wherein said at least one door is configured to be moved between a first position in which said work area is accessible at said front of said work station and said door is located generally parallel to one of said sides of said frame and a second position in which said door extends across at least a portion of said work area.

4. The work station in accordance with claim 3 wherein said door is mounted to one or more mounts which extend outwardly from said side of said frame.

5. The work station in accordance with claim 3 wherein said door is configured to engage a slot in said workbench when said door is in said second position.

6. The work station in accordance with claim 1 wherein said bottom of said frame comprises a platform and said at least one sub-station is configured to be located o said platform.

7. The work station in accordance with claim 1 wherein a front edge of said workbench extends forwardly beyond a front of said frame.

8. The work station in accordance with claim 7 further comprising at least one tool mount associated with said workbench, said at least one tool mount configured to permit at least one tool to be mounted in a first position where said at least one tool is located inside said work area and a second position where said at least one tool extends forwardly beyond said front of said frame.

9. The work station in accordance with claim 1 further comprising at least one wheeled dolly configured to support at least one sub-station when removed from said work station.

10. The work station in accordance with claim 9 further comprising means for locking said at least one sub-station to said dolly.

11. The work station in accordance with claim 1 wherein said sub-station comprise one or more shelves, drawers, totes or bins located in said storage area.

12. The work station in accordance with claim 1 further comprising means for locking said at least one sub-station to said work station in said sub-station area.

13. The work station in accordance with claim 1 wherein said sub-station storage area is closed at said sides and back and accessible at said front and comprising a first sub-station and a second sub-station located in said sub-station storage area in side by side position.

14. The work station in accordance with claim 1 wherein sais at least one sub-station has a front and at least one handle located at said front for aiding a user in pulling said sub-station out of said sub-station storage area towards said front.

15. The work station in accordance with claim 1 further comprising at least one mass measuring device associated with said work station and configured to determine a mass of said at least one sub-station when said at least one sub-station is located in said sub-station area.

16. A method of using a modular, securable work station having a sub-station storage area and a workbench portion, comprising the steps of:
sliding a first work sub-station outwardly from said sub-station storage area towards a front of said work station onto a rollable dolly;
supporting said first work sub-station on said rollable dolly; and
rolling said first work sub-station on said rollable dolly away from said work station.

17. The method in accordance with claim 16 further comprising sliding a second work sub-station into said sub-station storage area in replacement of said first work sub-station.

18. The method in accordance with claim 16 wherein said sub-station storage area is located below a work bench and above a base and wherein said first work sub-station rests upon said base below said work bench.

19. The method in accordance with claim 16 wherein said first work sub-station comprises a housing having a top, bottom, opposing first and second sides, a back and a front and defining an internal storage area, wherein said top comprises a work surface and access to said internal storage area is provided through said front.

20. The method in accordance with claim 16 further comprising the step of locking said first work sub-station to said dolly.

21. The method in accordance with claim 16 further comprising weighing said second work sub-station before sliding said work sub-station into said sub-station storage area.

22. The method in accordance with claim 16 further comprising the steps of measuring a mass of said first sub-station before sliding said first sub-station out of said sub-station storage area, returning said first sub-station from said dolly to said sub-station storage area, and re-measuring a mass of said first sub-station after it is returned to said sub-station storage area.
